(19) United States
(12) Patent Application Publication
(10) Pub. No.: US 2012/0048121 A1
(43) Pub. Date: Mar. 1, 2012

(54) BREWING ASSEMBLY FOR AN AUTOMATIC HOT-DRINK MACHINE

(76) Inventor: Joerg KRUG, Steffenberg (DE)

(21) Appl. No.: 13/219,278

(22) Filed: Aug. 26, 2011

(30) Foreign Application Priority Data
Aug. 27, 2010 (DE) 102010037189.0

(51) Int. Cl. A47J 31/44

(52) U.S. Cl. 99/290

(57) ABSTRACT

A brewer for a vending machine has a brewing chamber, a capsule holder rotatably mounted in the brewing chamber and holding a capsule of the brewed beverage. The capsule holder is a sleeve open at both ends, and first and second closures have respective tools for penetrating the capsule in the capsule holder. The first closure is movable along a longitudinal axis of the brewing chamber and in a closure position can be pressed tightly against an insertion opening. The second closure in the brewing chamber is displaceable along the longitudinal axis of the brewing chamber and can shift relative to the end of the capsule holder directed away from the insertion opening so that at least in the closure position it is tightly pressed against the end of the capsule holder.

The invention relates to a brewing unit for a vending machine for producing a brewed beverage, for instance coffee, comprising a brewing chamber, a capsule holder rotatably mounted in the brewing chamber for receiving a capsule with an extraction material for the brewed beverage, at least one movable closure part located in the brewing chamber for closing of the capsule holder and for forming an extraction chamber that can be flowed through by a liquid extraction agent, and comprising means for penetrating the capsule in the capsule holder, the capsule holder being pivotable by a manually or motor-driven drive system between a loading position for receiving the capsule, a brewing position with closed brewing chamber, an ejection position for ejecting the capsule, and back into the loading position.

Such a configuration is for instance known from the EP 1 912 542 B1. In the prior art configuration it is deemed disadvantageous that the capsule holder is a cup-type element being open at one side. A respective capsule can be inserted into this capsule holder, and the brewing process can be started or also terminated, however it is necessary for such capsules that penetration means can act at the bottom of the capsule as well as at the top surface of the capsule. Therefore, in prior art, the bottom of the capsule holder is provided with penetration means that penetrate into the bottom of the capsules and open it when the brewing chamber is closed. The further penetration means provided at the closure part of the capsule penetrate into the top of the capsule and pierce it. When the brewing process is terminated, the capsule is to be ejected by turning the capsule holder. This causes problems, however, since the penetration means at the bottom of the capsule holder do not release the capsule, but retain it. It is therefore often difficult for the user to remove the capsule from the capsule holder.

Based on this prior art, it is the object of the invention to provide a brewing unit of the species mentioned above, in which, after termination of the brewing process, the capsules can be ejected from the capsule holder in a simple and nearly imperative way, without the capsule being held back by penetration means or the like.

For achieving this object, the invention proposes that the capsule holder is configured as a sleeve being open at both ends and two closure parts with respective means for penetrating the capsule in the capsule holder are provided, wherein a first closure part is movable along a longitudinal axis of the brewing chamber in the direction of the insertion opening of the capsule holder and at least in the closure position can be pressed tightly against the insertion opening, wherein a second closure part is either non-displaceably arranged in the brewing chamber, the capsule holder being displaceable along the longitudinal axis of the brewing chamber and at least in the closure position being pressed, with its end directed from the insertion opening, tightly against the second closure part, or a second closure part is arranged in the brewing chamber and is displaceable along the longitudinal axis of the brewing chamber and is adjustable in the direction of the end of the capsule holder directed away from the insertion opening and against this direction, so that at least in the closure position it is tightly pressed against the end of the capsule holder.

Two possible solutions are stated in the claim. Basically, it is provided in the invention that the capsule holder is configured as a sleeve being open at both ends. This means that a capsule can be introduced into the capsule holder and can be held therein, the capsule being affected neither at the side of the orifice at its top surface nor at the bottom side by the penetration means of the capsule holder. Rather, these surfaces are open and without any retention devices. The means for penetrating the capsule are formed on the one hand at the first closure part and on the other hand at the second closure part. A first solution of the invention provides that the capsule holder is held rotatably only, not however displaceably in the longitudinal direction of the brewing chamber. The first closure part is displaceable along a longitudinal axis of the brewing chamber, and the second closure part is also displaceable. In this configuration, the sequence is such that first at the beginning of the preparation process the capsule holder is in a position, where the opening for receiving the capsules shows upwardly. The first and second closure parts are each displaced back into their final position. When the capsule is now inserted into the capsule holder, the capsule holder is turned into the desired position, where its orifice is directed toward the first closure part and its end directed away from the orifice is directed toward the second closure part. Simultaneously, the closure parts are displaced toward the capsule holder, in the final position the closure parts resting tightly against the orifice or against the other end of the capsule holder, respectively, and pierce with their penetration elements through the capsule bottom or the capsule cover, respectively, of the inserted capsule, so that the capsule can be flowed through by hot water and the preparation of the beverage can take place. After termination of the brewing process, the two closure parts are moved away from the capsule holder, and the capsule holder is turned so far that its filler hole shows downwardly, so that the capsule in the capsule holder can be ejected downwardly. There is no obstacle that could retain the capsule, but the capsule is freely ejectable.

Thereafter all elements are returned into the original position, and a new brewing process can be started with a new capsule.

In the alternative solution, the first closure part is again displaceable in the direction of the longitudinal axis of the brewing chamber. The capsule holder is rotatable and also displaceable along the longitudinal axis of the brewing chamber. The second closure part is stationary in the chamber. Here, the sequence is as follows. In the original position, the capsule holder shows upwardly with its insertion opening for the capsule. The capsule can be put in place. Thereafter the capsule holder is turned, so that its orifice is directed toward the first closure part and its other end is directed toward the second closure part. Then the first closure part and the capsule holder are displaced in the direction of the second closure part along the longitudinal axis of the brewing chamber, until all parts are resting tightly against each other. In this position, the capsule is opened by the penetration means of the first closure part and the penetration means of the second closure part, so that the brewing process can be performed.

After termination of the brewing process, the first closure part is displaced back and also the capsule holder is removed from the second closure part, until a sufficient distance is obtained, so that the capsule holder can be turned. The capsule holder is then turned so that its filler hole shows downwardly, so that the capsule being therein can be ejected. Here, too, no retention means in the form of penetration means or the like are present, but the capsule is freely movable in the capsule holder. Thereafter a return movement of all elements into the original position takes place, so that then a new brewing process can be started.

In order to be able to perform the actuation in an as simple manner as possible, it is provided that the brewing unit comprises a rotatably mounted capsule holder and one first and one second closure part each displaceable in the direction of the longitudinal axis of the brewing chamber, the chamber comprising crank wheels with connecting rods supported in side walls, and the first closure part is movable by means of the crank wheels, the second closure part is movable by means of the connecting rods, and the capsule holder is rotatable by means of cams of the crank wheels.

In the alternative solution it is provided for the same reason that the brewing unit comprises a rotatably mounted capsule holder being movable in the direction of the longitudinal axis of the brewing chamber, a first closure part being movable in the direction of the longitudinal axis of the brewing chamber as well as a stationary second closure part, the chamber comprising crank wheels with connecting rods supported in side walls, and the first closure part being movable by means of the connecting rods and the capsule holder being rotatable by means of cams and control curves of the crank wheels and being movable in the direction of the longitudinal axis.

In particular, it is provided in both solutions that the crank wheels can be driven by means of a stepper motor with a drive shaft.

In the following, the invention is explained in more detail with reference to examples of execution. There are:

FIG. 1 a first embodiment of the invention in an oblique view;

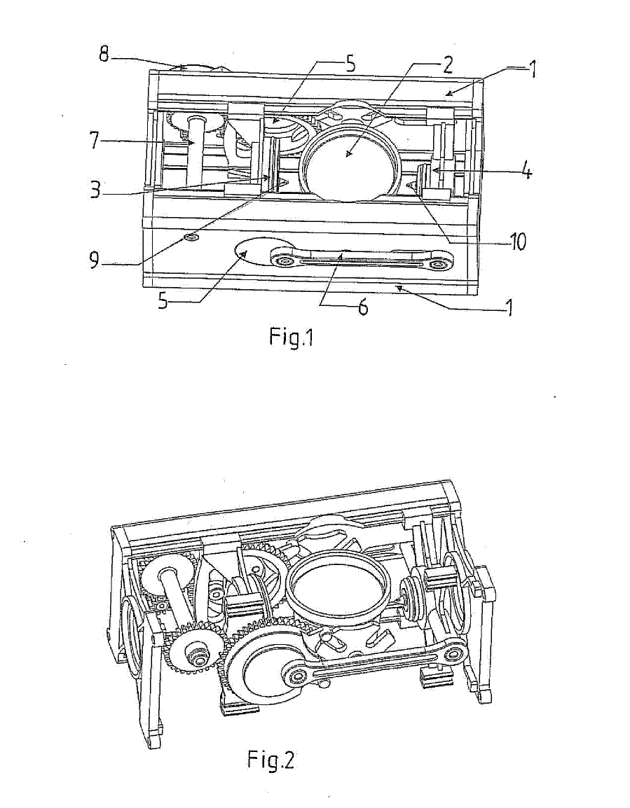

FIG. 2 to FIG. 14 details of the device in different functional positions;

FIG. 15 a view of a variant;

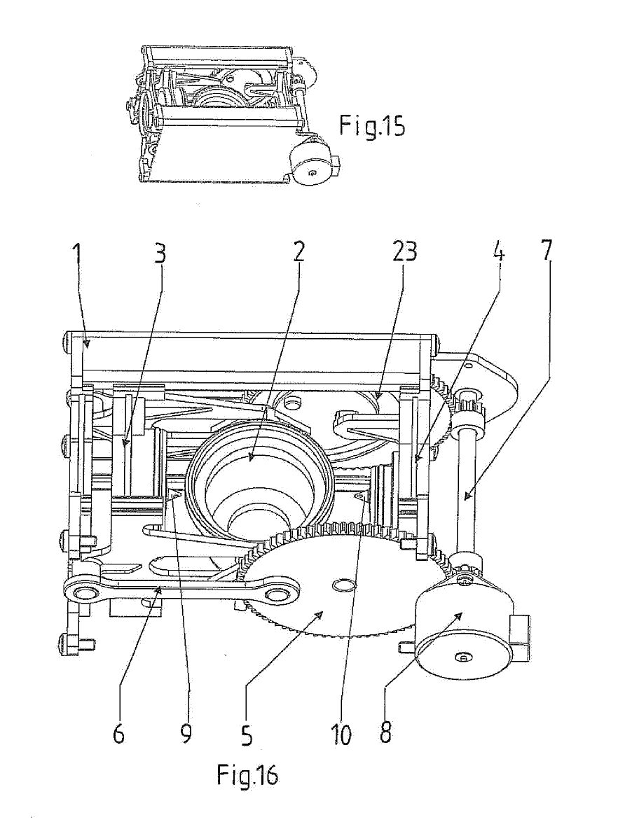

FIG. 16 to FIG. 33 details and different functional positions of the variant.

In order to simplify the processing of beverage capsules in a vending machine for the consumer, the design of a brewing unit of the vending machine comprises an automated capsule ejection in a compact construction. The constructive solutions are mechanical, and in the example a stepper motor is is provided as a drive mechanism.

In detail:

In FIG. 1, the essential elements of a brewing unit are shown. It consists of a housing 1, which so to speak forms or contains the brewing unit and which totally encloses a brewing chamber. At the housing, a capsule holder 2 is indirectly rotatably mounted, which receives a beverage capsule during the brewing process. Further, closure parts are provided, namely a first closure part 3 movable in the longitudinal direction of the central axis of the brewing chamber and a second closure part 4 movable in the same direction. The movement takes place by means of two crank wheels 5, which are aligned coaxially to each other, in connection with two connecting rods 6. (In FIG. 1 only one can be seen. The other one is on the rear side that cannot be seen in the drawing). The first closure part 3 and the second closure part 4 are mechanically displaceably connected with each other. The rotation of the capsule holder 2 is effected by corresponding cams at the crank wheels 5. The crank wheels 5 are synchronously driven by means of a drive shaft 7 and a stepper motor 8. The housing 1 comprises guide elements for the first and second closure parts 3, 4, as well as elements for supporting the capsule holder 2, the crank wheels 5, the drive shaft 7 and the stepper motor 8.

The brewing process essentially takes place in three steps, in which the components are in different positions, namely the loading position, the brewing position and the ejection position.

In FIGS. 1 and 2, the loading position is shown. Herein, the brewing unit is opened, that means, the first closure part 3 and the second closure part 4 are moved apart and the capsule holder 2 shows upwardly with its filler hole. The capsule holder is configured as a sleeve being open on both sides.

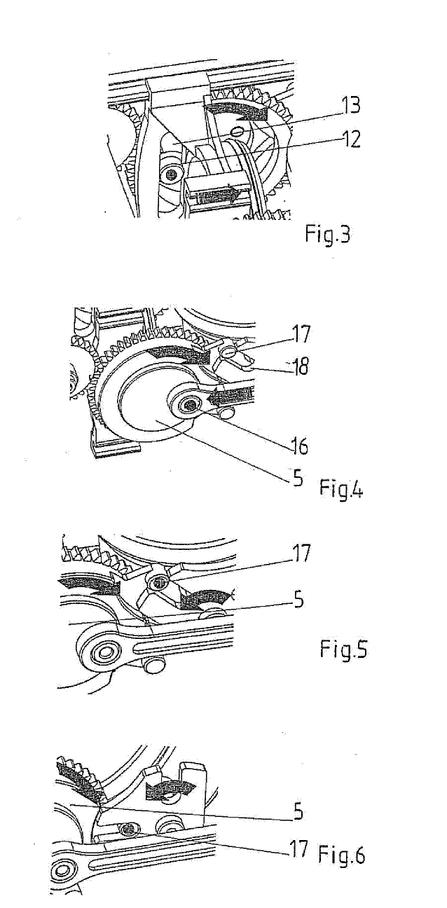

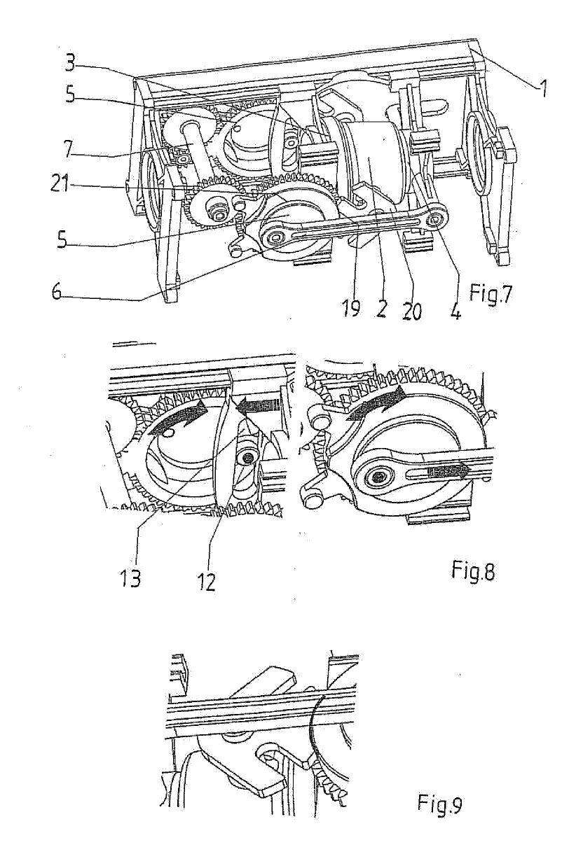

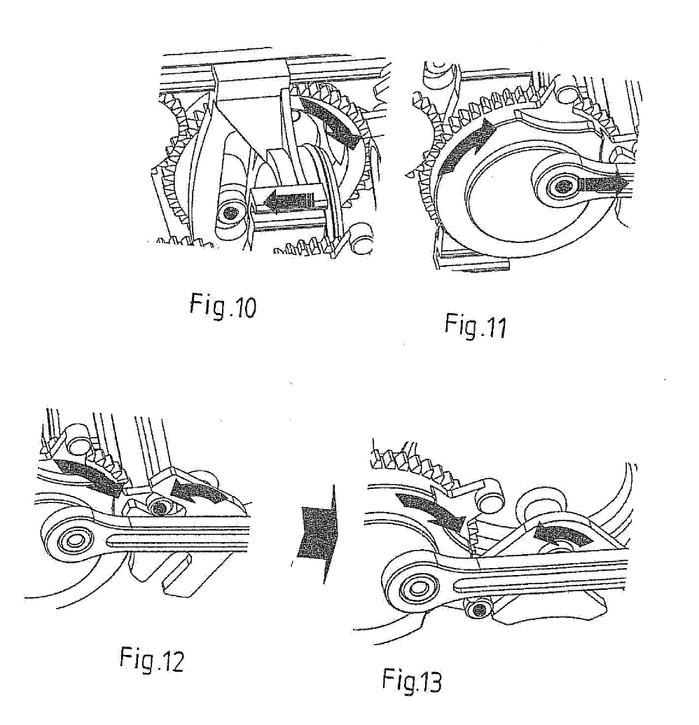

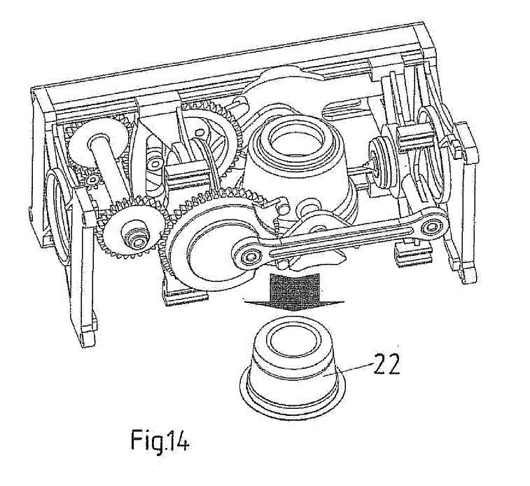

The penetration means for opening the capsule, which is inserted into the capsule holder, are arranged at the first closure part 3 and at the second closure part 4. The penetration means 9 or 10, respectively, are for instance shown in FIG. 1. In the position according to FIGS. 1 and 2, the beverage capsule can be inserted into the capsule holder 2. Thereafter, the brewing process is started. The stepper motor 8 drives the crank wheels 5 by means of the drive shaft 7. By means of a large control cam 12 at the inner side of the crank wheels 5 or by means of the connecting rods 6 being arranged eccentrically at the outer side of the crank wheels 5, respectively, the first and the second closure parts 3, 4 are moved together. Simultaneously, the capsule holder 2 is turned by 90° by an external control cam 16 of the crank wheels 5. This is shown in FIGS. 3 to 6. In FIG. 3, the cam 12 on the inner side of the crank wheels 5 is shown, which moves in an oblong hole, and which is part of the kinematics of the first closure part 3. In FIG. 4, the cam 16 on the outer side of the crank wheel 5 is shown, by means of which the second closure part 4 is displaced by means of the connecting rod 6. The external cam 17 at the crank wheels 5 in turn engages a control groove 18 of the capsule holder 2, so that it is caught and turned, as can be seen in the comparison of FIGS. 4 to 6. In the position according to FIG. 7, the brewing unit is closed. The first and the second closure parts 3, 4 are moved together and tightly engage the orifice or the bottom side of the capsule holder 2 being rotated by 90° with respect to the original position in FIG. 1, respectively. By seals at the closure parts 3, 4, the capsule holder 2 is sealed. Through hose connections at the closure parts 3, 4, hot water can be fed from the first closure part 3 through the capsule in the capsule holder 2 toward the second closure part 4. At this closure part, the finished beverage exits through a corresponding discharge line. When the brewing unit is completely moved together, as shown in FIG. 7, then this position is maintained, until the beverage is prepared. Thereafter, the stepper motor 8 drives the crank wheels 5 onward, in the same direction of rotation, in order to open the brewing unit again. The further sequences are shown in FIGS. 8 to 13. The contour 19 at the control elements 20 of the capsule holder 2 prevents, in connection with the contour 21 of the crank wheels 5, a rotation of the capsule holder 2. Only another turning of the crank wheel 5, as shown in FIGS. 10, 11 and 12, has again effect on the control element 20 of the capsule holder 2 by means of the cams 17 of the crank wheel 5, and the capsule holder 2 is turned downwardly by another 90°. Shortly before the ejection position is reached, as shown in FIGS. 12 and 13, turning of the capsule holder 2 by another 90° is effected by the external cams at the crank wheels 5 by means of another groove in the control element 20 of the capsule holder 2. As a result, then the position is achieved as shown in FIG. 14. Now, the brewing unit is opened, the first and the second closure parts 3, 4 are moved apart and the capsule holder 2 is directed downwardly with its filler hole. Thus, the beverage capsule 22 can downwardly fall out. Since the capsule holder is open at top and bottom, there are no obstacles that could hold the capsule 22 back.

When the brewing unit has been moved into the ejection position and the beverage capsule 22 has been ejected, the brewing unit moves back into the loading position according to FIG. 1. For this purpose, the stepper motor 8 drives the crank wheels 5 in an opposite direction. The complete process proceeds in a reverse direction, until the loading position is again obtained.

In the embodiment according to FIGS. 15 to 33, identical parts have obtained identical reference numerals. In contrast to the solution according to FIGS. 1 to 14, herein the capsule holder 2 is not only rotatable, but also displaceable, whereas the second closure part 4 is stationary in the housing 1. The control discs 5 are supported at the housing. By turning the control discs 5, the first closure part 3 is displaced by means of the connecting rods 6. Simultaneously, the capsule holder 2 is moved by the control curve 23 in the control disc 5 and is turned by means of cams arranged internally at the control discs. The control discs 5 are synchronously driven by means of a drive shaft 7 and a stepper motor. The housing simultaneously comprises guides for the displacement of the first closure part 3.

In FIGS. 15 to 17, the loading position is shown. Herein, the brewing unit is opened. The first closure part 3 is maximally moved to the left in the drawing. The capsule holder 2 is also maximally moved to the left and shows upwardly with its filler hole. The capsule holder 2 is again configured as a sleeve being open on both sides. The penetration means 9, 10 for the capsule are arranged at the closure parts 3, 4.

In this position, the beverage capsule can be inserted into the capsule holder 2, and the brewing process can be started.

The capsule holder 2 is supported in the control curve 23 as well as in a groove of the first closure part 3 and is fixed by the cams of the control disc 5. When the brewing process is started, the stepper motor 8 drives the control discs 5 by means of the drive shaft 7. By the rotation of the control discs 5 and the contour of the control curve, the capsule holder 2 is moved and simultaneously turned by the cams of the control discs 5. By means of the connecting rods 6, simultaneously the first closure part 3 is moved to the right.

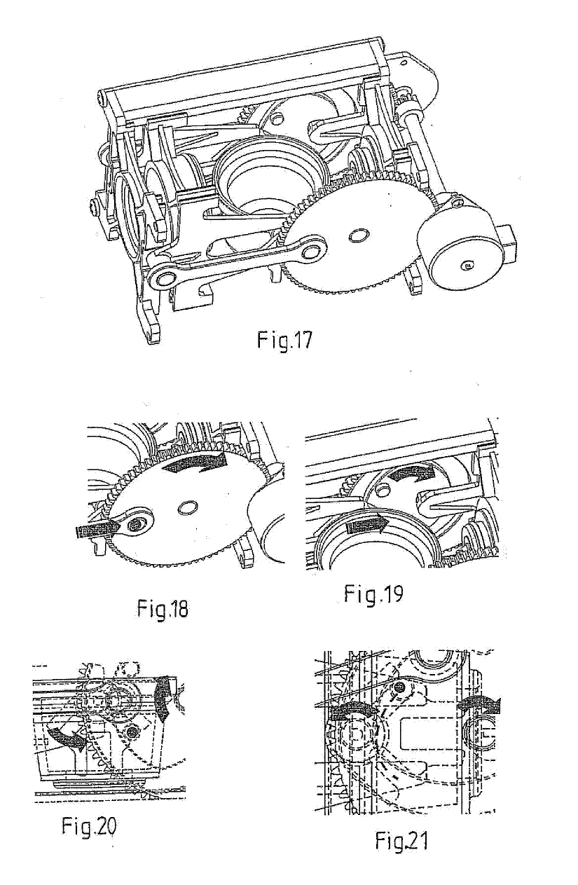

The movement sequences are shown in detail in the FIGS. In FIG. 18 it is shown that when turning the control discs 5, the first closure part 3 is displaced by the connecting rods 6. In FIG. 19 it is shown, how the control curve in the control discs 5 moves the capsule holder 2. This is also shown in FIGS. 20 and 21. The cams at the inner side of the control discs 5 turn the capsule holder 2.

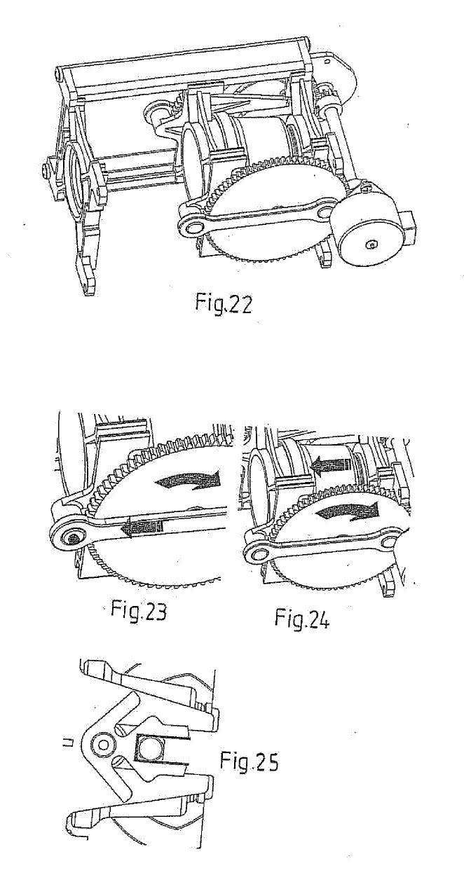

In FIG. 22 it is shown that the brewing unit is closed. The first closure part 3 is moved to the right. The capsule holder 2 is rotated by 90° and also moved to the right. By seals at the first closure part 3 and at the second closure part 4, the capsule holder 2 sealed. By means of hose connections at the first closure part 3 and at the second closure part 4, hot water can be fed from the entry through the capsule holder 2 to the outlet. At the outlet the finished beverage can be taken out.

When the brewing unit is completely moved together, this position is maintained, until the beverage is prepared. Thereafter, the stepper motor 8 again drives the control discs 5, in order to open the brewing unit. This is shown in the further FIGS. 23 to 29.

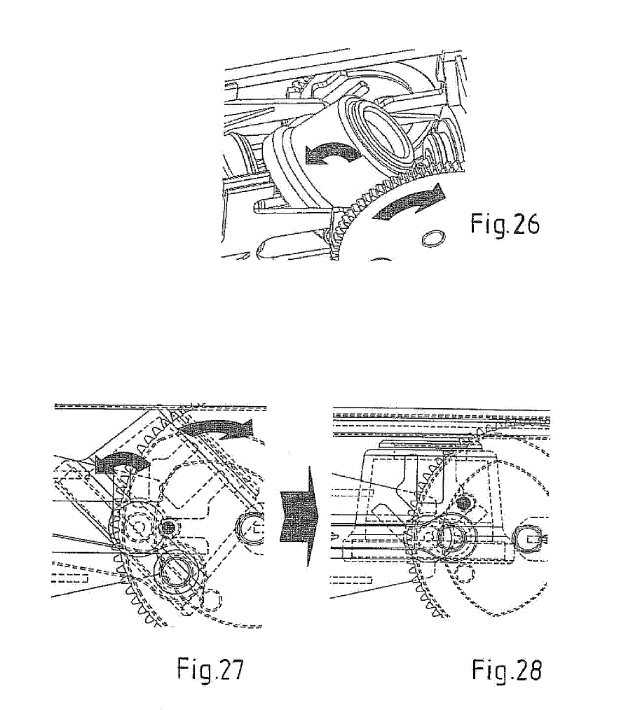

A groove in the control disc of the capsule holder 2, which encloses the support of the control disc in the second closure part, prevents the rotation of the capsule holder 2, when the cams for turning the capsule holder 2 are not in engagement. As shown in FIGS. 26 to 28, the following occurs. Shortly before the ejection position is reached, the cams at the inner side of the control discs 5 turn the capsule holder 2 by another 90° by means of another groove.

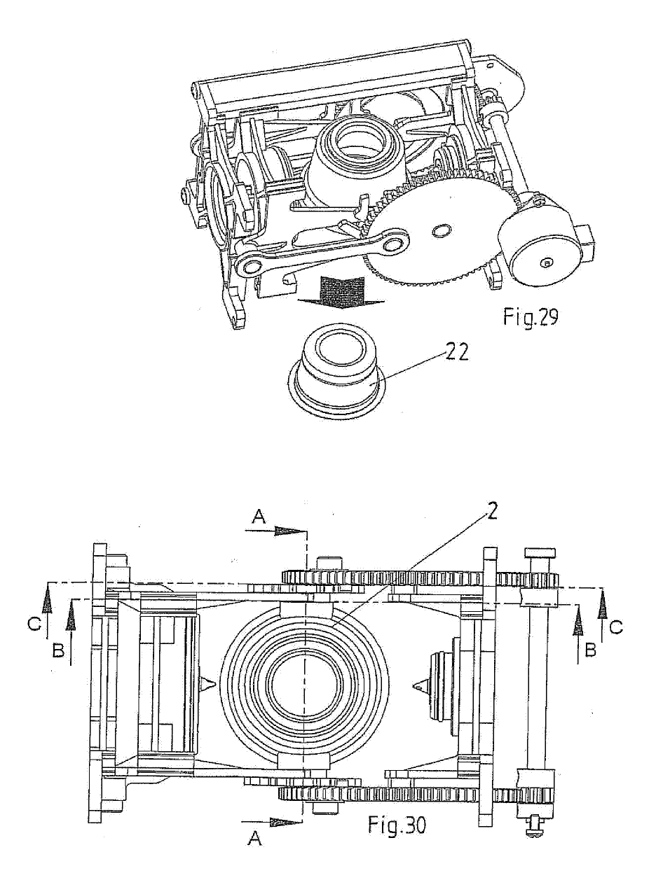

The final position is then achieved according to FIG. 29. When the beverage capsule has then been ejected, the brewing unit moves back into the loading position. For this purpose, the stepper motor 8 drives the control discs 5 in the opposite direction. The complete process proceeds in a reverse direction, until the loading position is again obtained.

In FIG. 29, the brewing unit is opened. The first closure part 3 is displaced to the left into the maximum position. The capsule holder 2 is maximally moved to the left and is directed downwardly. The beverage capsule 22 can downwardly be ejected.

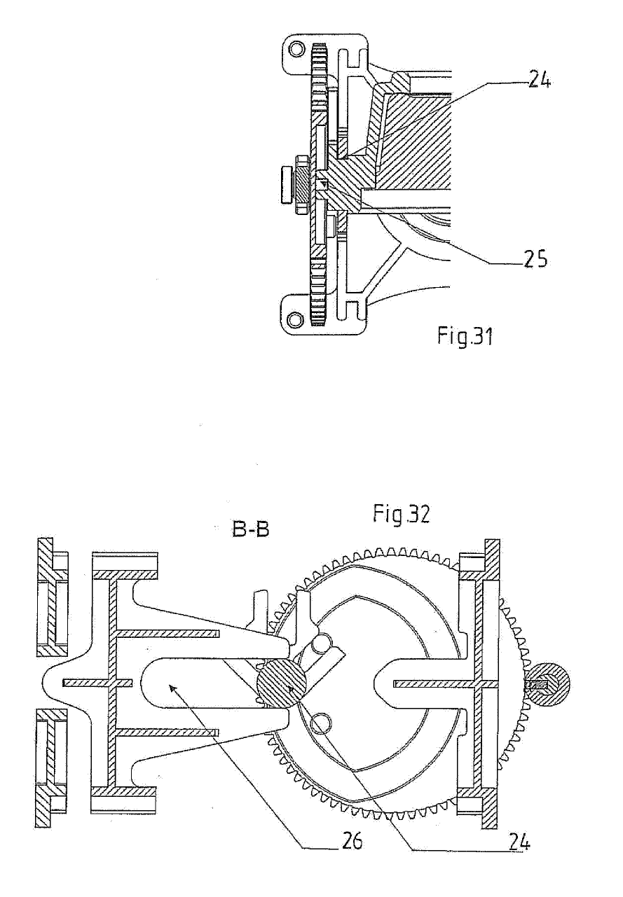

In FIG. 30, the support of the capsule holder 2 is again clearly shown. The representation is a top view without housing parts and without connecting rod. The capsule holder 2 is linearly guided on a larger bearing pin in a groove of the first closure part (see section B-B) and simultaneously on a smaller bearing pin in the control curve of the control disc 5 (see section C-C). By this combined support, the capsule holder 2 is fixed in its position. The large bearing pin is designated in FIG. 31 with 24, whereas the small bearing pin is designated with 25. In the section B-B, the large bearing pin 24 and the groove 26 are shown, which is part of the first closure part 3.

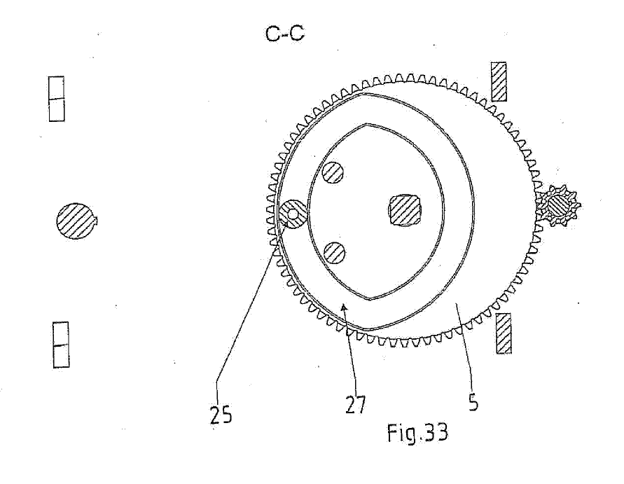

Finally, in FIG. 33 are shown the small bearing pin 25 and the control curve 27 in the control disc 5.

The invention is not limited to this embodiment, but is in many ways variable within the scope of the disclosure.

All novel individual or combined features disclosed in the description and/or drawing are deemed essential for the invention.

1. A brewing unit for a vending machine for producing a brewed beverage, for instance coffee, comprising a brewing chamber, a capsule holder rotatably mounted in the brewing chamber for receiving a capsule with an extraction material for the brewed beverage, at least one movable closure part located in the brewing chamber for closing the capsule holder and for forming an extraction chamber that can be flowed through by a liquid extraction agent, as well as comprising means for penetrating the capsule in the capsule holder, the capsule holder being pivotable by a manually or motor-driven drive system between a loading position for receiving the capsule, a brewing position with closed brewing chamber, an ejection position for ejecting the capsule, and back into the loading position, wherein the capsule holder is configured as a sleeve being open at both ends, and two closure parts with respective means for penetrating the capsule in the capsule holder are provided, wherein a first closure part is movable along a longitudinal axis of the brewing chamber in the direction of the insertion opening of the capsule holder and at least in the closure position can be pressed tightly against the insertion opening, wherein a second closure part is either non-displaceably arranged in the brewing chamber, the capsule holder being displaceable along the longitudinal axis of the brewing chamber and at least in the closure position being pressed, with its end directed from the insertion opening, tightly against the second closure part, or a second closure part is arranged in the brewing chamber and is displaceable along the longitudinal axis of the brewing chamber and is adjustable in the direction of the end of the capsule holder directed away from the insertion opening and against this direction, so that at least in the closure position it is tightly pressed against the end of the capsule holder.

2. The brewing unit according to claim 1, wherein the brewing unit comprises a rotatably mounted capsule holder and one first and second closure part each displaceable in the direction of the longitudinal axis of the brewing chamber, the chamber comprising crank wheels with connecting rods supported in side walls, and the first closure part is movable by means of the crank wheels, the second closure part is movable by means of the connecting rods, and the capsule holder is rotatable by means of cams of the crank wheels.

3. The brewing unit according to claim 1, wherein the brewing unit comprises a rotatably mounted capsule holder being movable in the direction of the longitudinal axis of the brewing chamber, a first closure part being movable in the direction of the longitudinal axis the brewing chamber as well as a stationary second closure part, the chamber comprising crank wheels with connecting rods supported in side walls, and the first closure part is movable by means of the connecting rods, and the capsule holder is rotatable by means of cams and control curves of the crank wheels and is movable in the direction of the longitudinal axis.

4. The brewing unit according to claim 1, wherein the crank wheels can be driven by means of a stepper motor with a drive shaft.
